(19) United States
(12) Patent Application Publication
(10) Pub. No.: US 2026/0253456 A1
(43) Pub. Date: Aug. 27, 2026

(54) USER DATA TRANSFER BETWEEN VEHICLES

(71) Applicant: Textron Inc., Providence, RI (US)

(72) Inventors: Preston Sering Easley, Martinez, GA (US); Jonathan Luis Valdes, Graniteville, SC (US)

(73) Assignee: Textron Inc., Providence, RI (US)

(21) Appl. No.: 19/062,910

(22) Filed: Feb. 25, 2025

(51) Int. Cl. G07C 5/00; G05D 1/69; G05D 105/22; G05D 105/60; G06Q 10/0631

(52) U.S. Cl. CPC G07C 5/008; G05D 1/69; G05D 2105/22; G05D 2105/60; G06Q 10/06311

(57) ABSTRACT

A golf cart system includes one or more processing circuits including one or more memory devices coupled to one or more processors. The one or more memory devices are configured to store instructions thereon that, when executed by the one or more processors, cause the one or more processors to: determine that a first golf cart operating on a golf course is experiencing a fault preventing further use of the first golf cart by a golfer and transfer data at least one of stored on the first golf cart or associated with the golfer to a second golf cart at least in response to the fault.

### BACKGROUND

Golfers may utilize golf carts to travel around a golf cart. Faults may occur on golf carts that cause a golf cart to become non-operational, thereby causing the non-operational golf cart to be replaced with a second, operational vehicle. When the golf cart is replaced, data, including user data and data relating to a current round of golf, may be lost.

### SUMMARY

One embodiment relates to a golf cart system. The golf cart system includes one or more processing circuits including one or more memory devices coupled to one or more processors. The one or more memory devices are configured to store instructions thereon that, when executed by the one or more processors, cause the one or more processors to determine that a first golf cart operating on a golf course is experiencing a fault preventing further use of the first golf cart by a golfer and transfer data at least one of stored on the first golf cart or associated with the golfer to a second golf cart at least in response to the fault.

Another embodiment relates to a system. The system includes one or more processing circuits including one or more memory devices coupled to one or more processors. The one or more memory devices are configured to store instructions thereon that, when executed by the one or more processors, cause the one or more processors to determine that a first golf cart operating on a golf course is experiencing a fault preventing further use of the first golf cart by a golfer, transfer data at least one of stored on the first golf cart or associated with the golfer to a second golf cart at least in response to the fault, monitor first locations of the first golf cart as the first golf cart drives around the golf course, generate a cart trail based on the first locations, determine a fault location of the first golf cart when the fault occurs, monitor second locations of the second golf cart as the second golf cart drives around the golf course, and continue generating the cart trail from the fault location based the second locations.

Still another embodiment relates to a golf cart system. The golf cart system includes one or more processing circuits including one or more memory devices coupled to one or more processors. The one or more memory devices are configured to store instructions thereon that, when executed by the one or more processors, cause the one or more processors to determine that a first golf cart operating on a golf course is experiencing a fault preventing further use of the first golf cart by a golfer, transfer data at least one of stored on the first golf cart or associated with the golfer to a second golf cart at least in response to the fault, monitor a location of the first golf cart, dispatch the second golf cart to the location of the first golf cart, and one of (a) autonomously drive to the second golf cart to the location or (b) assign the second golf cart to the golfer and instruct a staff member associated with the golf course to drive the second golf cart to the location.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a perspective view of a vehicle, according to an exemplary embodiment.

FIG. 2 is a schematic block diagram of the vehicle of FIG. 1, according to an exemplary embodiment.

FIG. 3 is another schematic block diagram of the vehicle of FIG. 1, according to an exemplary embodiment.

FIG. 4 is a schematic block diagram of a fleet monitoring and control system including a plurality of the vehicles of FIG. 1, according to an exemplary embodiment.

FIG. 5 is a block diagram of a data transfer manager, according to an exemplary embodiment.

FIG. 6 is a flow diagram of a method for data transfer, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

### Overall Vehicle

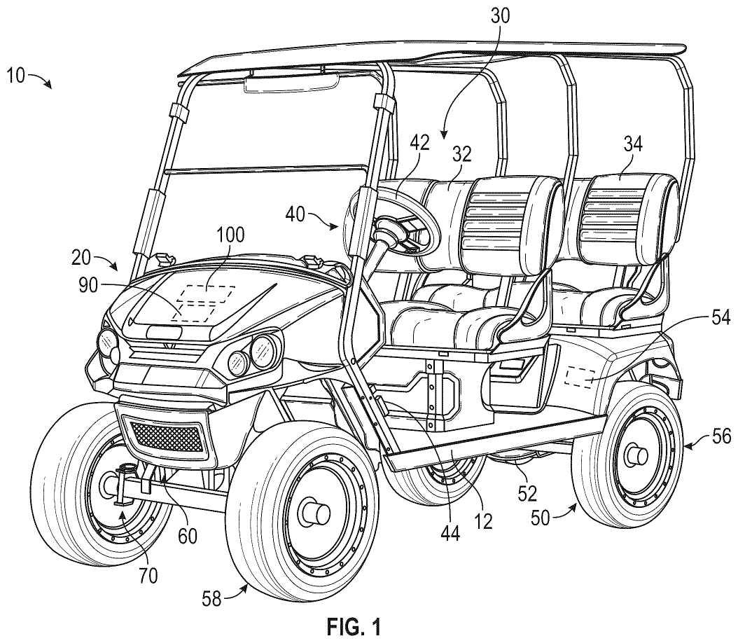

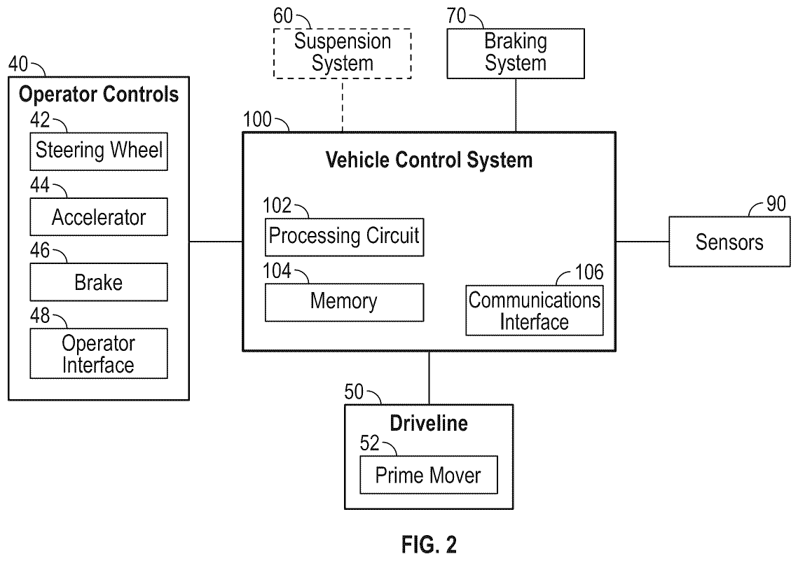

As shown in FIGS. 1 and 2, a machine or vehicle, shown as vehicle 10, includes a chassis, shown as frame 12; a body assembly, shown as body 20, coupled to the frame 12 and having an occupant portion or section, shown as occupant seating area 30; operator input and output devices, shown as operator controls 40, that are disposed within the occupant seating area 30; a drivetrain, shown as driveline 50, coupled to the frame 12 and at least partially disposed under the body 20; a vehicle suspension system, shown as suspension system 60, coupled to the frame 12 and one or more components of the driveline 50; a vehicle braking system, shown as braking system 70, coupled to one or more components of the driveline 50 to facilitate selectively braking the one or more components of the driveline 50; one or more first sensors, shown as sensors 90; and a control system, shown as vehicle control system 100, coupled to the operator controls 40, the driveline 50, the suspension system 60, the braking system 70, and the sensors 90. In some embodiments, the vehicle 10 includes more or fewer components.

According to an exemplary embodiment, the vehicle 10 is an off-road machine or vehicle. In some embodiments, the off-road machine or vehicle is a lightweight or recreational machine or vehicle such as a golf cart or vehicle, an all-terrain vehicle (“ATV”), a utility task vehicle (“UTV”), a low speed vehicle (“LSV”), a personal transport vehicle (“PTV”), a hauler, and/or another type of lightweight or recreational machine or vehicle. In some embodiments, the off-road machine or vehicle is a chore product such as a lawnmower, a turf mower, a push mower, a ride-on mower, a stand-on mower, aerator, turf sprayers, bunker rake, another type of chore product that may be used on a golf course, a ground support equipment (“GSE”) that may be used at an airport, and/or still other off-road machines or vehicles.

According to the exemplary embodiment shown in FIG. 1, the occupant seating area 30 includes a plurality of rows of seating including a first row of seating, shown as front row seating 32, and a second row of seating, shown as rear row seating 34. In some embodiments, the occupant seating area 30 includes a third row of seating or intermediate/middle row seating positioned between the front row seating 32 and the rear row seating 34. According to the exemplary embodiment shown in FIG. 1, the rear row seating 34 is facing forward. In some embodiments, the rear row seating 34 is facing rearward. In some embodiments, the occupant seating area 30 does not include the rear row seating 34. In some embodiments, in addition to or in place of the rear row seating 34, the vehicle 10 includes one or more rear accessories. Such rear accessories may include a golf bag rack, a bed, a cargo body (e.g., for a drink cart), and/or other rear accessories.

According to an exemplary embodiment, the operator controls 40 are configured to provide an operator with the ability to control one or more functions of and/or provide commands to the vehicle 10 and the components thereof (e.g., turn on, turn off, drive, turn, brake, engage various operating modes, raise/lower an implement, etc.). As shown in FIGS. 1 and 2, the operator controls 40 include a steering interface (e.g., a steering wheel, joystick(s), etc.), shown steering wheel 42, an accelerator interface (e.g., a pedal, a throttle, etc.), shown as accelerator 44, a braking interface (e.g., a pedal), shown as brake 46, and one or more additional interfaces, shown as operator interface 48. The operator interface 48 may include one or more displays and one or more input devices. The one or more displays may be or include a touchscreen, a LCD display, a LED display, a speedometer, gauges, warning lights, etc. The one or more input devices may be or include buttons, switches, knobs, levers, dials, etc.

According to an exemplary embodiment, the driveline 50 is configured to propel the vehicle 10. As shown in FIGS. 1 and 2, the driveline 50 includes a primary driver, shown as prime mover 52, an energy storage device, shown as energy storage 54, a first tractive assembly (e.g., axles, wheels, tracks, differentials, etc.), shown as rear tractive assembly 56, and a second tractive assembly (e.g., axles, wheels, tracks, differentials, etc.), shown as front tractive assembly 58. In some embodiments, the driveline 50 is a conventional driveline whereby the prime mover 52 is an internal combustion engine and the energy storage 54 is a fuel tank. The internal combustion engine may be a spark-ignition internal combustion engine or a compression-ignition internal combustion engine that may use any suitable fuel type (e.g., diesel, ethanol, gasoline, natural gas, propane, etc.). In some embodiments, the driveline 50 is an electric driveline whereby the prime mover 52 is an electric motor (e.g., the motor 53) and the energy storage 54 is a battery system (e.g., the battery module 57, the add-on battery module(s) 59, etc.). In some embodiments, the driveline 50 is a fuel cell electric driveline whereby the prime mover 52 is an electric motor and the energy storage 54 is a fuel cell (e.g., that stores hydrogen, that produces electricity from the hydrogen, etc.). In some embodiments, the driveline 50 is a hybrid driveline whereby (i) the prime mover 52 includes an internal combustion engine and an electric motor/generator and (ii) the energy storage 54 includes a fuel tank and/or a battery system. According to the exemplary embodiment shown in FIG. 1, the rear tractive assembly 56 includes rear tractive elements and the front tractive assembly 58 includes front tractive elements that are configured as wheels. In some embodiments, the rear tractive elements and/or the front tractive elements are configured as tracks.

According to an exemplary embodiment, the prime mover 52 is configured to provide power to drive the rear tractive assembly 56 and/or the front tractive assembly 58 (e.g., to provide front-wheel drive, rear-wheel drive, four-wheel drive, and/or all-wheel drive operations). In some embodiments, the driveline 50 includes a transmission device (e.g., a gearbox, a continuous variable transmission (“CVT”), etc.) positioned between (a) the prime mover 52 and (b) the rear tractive assembly 56 and/or the front tractive assembly 58. The rear tractive assembly 56 and/or the front tractive assembly 58 may include a drive shaft, a differential, and/or an axle. In some embodiments, the rear tractive assembly 56 and/or the front tractive assembly 58 include two axles or a tandem axle arrangement. In some embodiments, the rear tractive assembly 56 and/or the front tractive assembly 58 are steerable (e.g., using the steering wheel 42). In some embodiments, both the rear tractive assembly 56 and the front tractive assembly 58 are fixed and not steerable (e.g., employ skid steer operations).

In some embodiments, the driveline 50 includes a plurality of prime movers 52. By way of example, the driveline 50 may include a first prime mover 52 that drives the rear tractive assembly 56 and a second prime mover 52 that drives the front tractive assembly 58. By way of another example, the driveline 50 may include a first prime mover 52 that drives a first one of the front tractive elements, a second prime mover 52 that drives a second one of the front tractive elements, a third prime mover 52 that drives a first one of the rear tractive elements, and/or a fourth prime mover 52 that drives a second one of the rear tractive elements. By way of still another example, the driveline 50 may include a first prime mover 52 that drives the front tractive assembly 58, a second prime mover 52 that drives a first one of the rear tractive elements, and a third prime mover 52 that drives a second one of the rear tractive elements. By way of yet another example, the driveline 50 may include a first prime mover 52 that drives the rear tractive assembly 56, a second prime mover 52 that drives a first one of the front tractive elements, and a third prime mover 52 that drives a second one of the front tractive elements.

According to an exemplary embodiment, the suspension system 60 includes one or more suspension components (e.g., shocks, dampers, springs, etc.) positioned between the frame 12 and one or more components (e.g., tractive elements, axles, etc.) of the rear tractive assembly 56 and/or the front tractive assembly 58. In some embodiments, the vehicle 10 does not include the suspension system 60.

According to an exemplary embodiment, the braking system 70 includes one or more braking components (e.g., disc brakes, drum brakes, in-board brakes, axle brakes, etc.) positioned to facilitate selectively braking one or more components of the driveline 50. In some embodiments, the one or more braking components include (i) one or more front braking components positioned to facilitate braking one or more components of the front tractive assembly 58 (e.g., the front axle, the front tractive elements, etc.) and (ii) one or more rear braking components positioned to facilitate braking one or more components of the rear tractive assembly 56 (e.g., the rear axle, the rear tractive elements, etc.). In some embodiments, the one or more braking components include only the one or more front braking components. In some embodiments, the one or more braking components include only the one or more rear braking components. In some embodiments, the one or more front braking components include two front braking components, one positioned to facilitate braking each of the front tractive elements. In some embodiments, the one or more rear braking components include two rear braking components, one positioned to facilitate braking each of the rear tractive elements. In some embodiments, electric regenerative braking is employed (e.g., via the prime mover 52, an electric motor, etc.) in combination with or instead of using the braking system 70 to facilitate braking of one or more components of the driveline 50.

The sensors 90 may include various sensors positioned about the vehicle 10 to acquire vehicle information or vehicle data regarding operation of the vehicle 10 and/or the location thereof. By way of example, the sensors 90 may include an accelerometer, a gyroscope, a compass, a position sensor (e.g., a GPS sensor, etc.), an inertial measurement unit (“IMU”), suspension sensor(s), wheel sensors, an audio sensor or microphone, a camera, an optical sensor, a proximity detection sensor, a Doppler sensor, and/or other sensors to facilitate acquiring vehicle information or vehicle data regarding operation of the vehicle 10 and/or the location thereof. According to an exemplary embodiment, one or more of the sensors 90 are configured to facilitate detecting and obtaining vehicle telemetry data including position of the vehicle 10, whether the vehicle 10 is moving, travel direction of the vehicle 10, slope of the vehicle 10, speed of the vehicle 10, vibrations experienced by the vehicle 10, sounds proximate the vehicle 10, suspension travel of components of the suspension system 60, and/or other vehicle telemetry data.

The vehicle control system 100 may be implemented as a general-purpose processor, an application specific integrated circuit (“ASIC”), one or more field programmable gate arrays (“FPGAs”), a digital-signal-processor (“DSP”), circuits containing one or more processing components, circuitry for supporting a microprocessor, a group of processing components, or other suitable electronic processing components. According to the exemplary embodiment shown in FIG. 2, the vehicle control system 100 includes a processing circuit 102, a memory 104, and a communications interface 106. The processing circuit 102 may include an ASIC, one or more FPGAs, a DSP, circuits containing one or more processing components, circuitry for supporting a microprocessor, a group of processing components, or other suitable electronic processing components. In some embodiments, the processing circuit 102 is configured to execute computer code stored in the memory 104 to facilitate the activities described herein. The memory 104 may be any volatile or non-volatile or non-transitory computer-readable storage medium capable of storing data or computer code relating to the activities described herein. According to an exemplary embodiment, the memory 104 includes computer code modules (e.g., executable code, object code, source code, script code, machine code, etc.) configured for execution by the processing circuit 102. In some embodiments, the vehicle control system 100 may represent a collection of processing devices. In such cases, the processing circuit 102 represents the collective processors of the devices, and the memory 104 represents the collective storage devices of the devices.

In one embodiment, the vehicle control system 100 is configured to selectively engage, selectively disengage, control, or otherwise communicate with components of the vehicle 10 (e.g., via the communications interface 106, a controller area network (“CAN”) bus, etc.). According to an exemplary embodiment, the vehicle control system 100 is coupled to (e.g., communicably coupled to) components of the operator controls 40 (e.g., the steering wheel 42, the accelerator 44, the brake 46, the operator interface 48, etc.), components of the driveline 50 (e.g., the prime mover 52), components of the braking system 70, and the sensors 90. By way of example, the vehicle control system 100 may send and receive signals (e.g., control signals, location signals, etc.) with the components of the operator controls 40, the components of the driveline 50, the components of the braking system 70, the sensors 90, and/or remote systems or devices (via the communications interface 106 as described in greater detail herein).

### Electrified Driveline

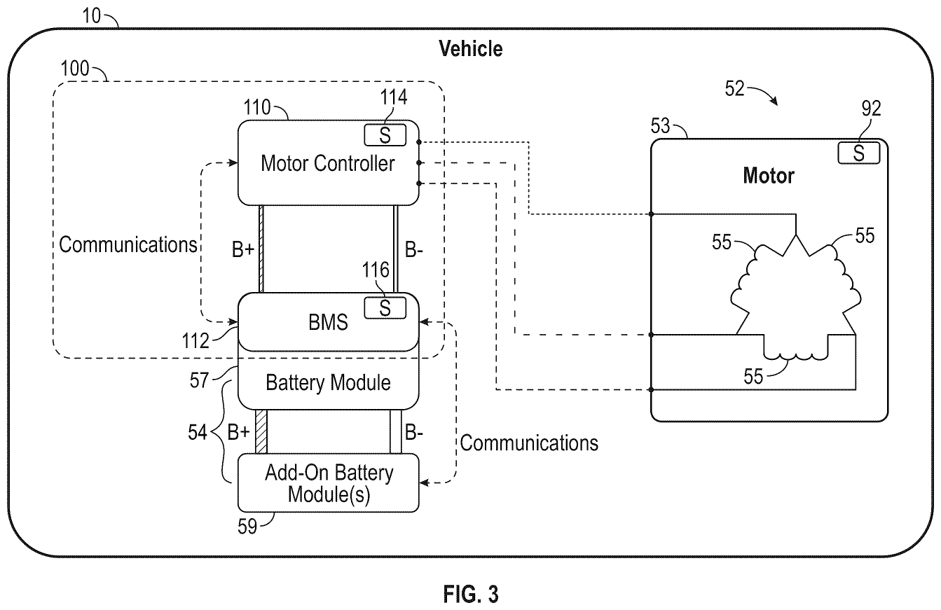

According to the exemplary embodiments shown in FIG. 3, the driveline 50 of the vehicle 10 is configured as an electrified driveline where (a) the prime mover 52 is configured as a three-phase, alternating current (“AC”) electric motor, shown as motor 53, including three sets of windings, shown as motor windings 55, and a first sensor, shown as motor sensor 92; (b) the energy storage 54 is configured as a battery system including a first battery pack or module, shown as battery module 57, and one or more second battery packs or modules, shown as add-on battery module(s) 59, electrically coupled to the battery module 57 in parallel; and (c) the vehicle control system 100 includes (i) a first controller, shown as motor controller 110, coupled to the motor 53 and including a second sensor, shown as motor controller sensor 114, and (ii) a second controller, shown as battery management system (“BMS”) 112, coupled to the motor controller 110 and the energy storage 54 (e.g., the battery system, the battery module 57, the add-on battery module(s) 59, etc.) and including a third sensor, shown as BMS sensor 116. In some embodiments, the motor 53 is configured as a separately excited DC motor. The motor sensor 92, the motor controller sensor 114, and/or the BMS sensor 116 may include a temperature sensor, a voltage sensor, a current sensor, a speed sensor, and/or another suitable sensor to facilitate monitoring at least one of the operational parameters (e.g., temperature, voltage, current, speed, SOC, rate of charge, rate of discharge, etc.) of the motor 53, the motor controller 110, the BMS 112, the battery module 57, and/or the add-on battery modules(s) 59. The motor controller 110 and the BMS 112 may each include a processing circuit 102, a memory 104, and a communications interface 106.

According to an exemplary embodiment, each of the battery module 57 and the add-on battery module(s) 59 of the battery system includes one or more rows and/or groups of battery cells. The BMS 112 may be configured to monitor characteristics of the rows and/or groups of battery cells and/or individual cells of the battery module 57 and the add-on battery module(s) 59 (e.g., using data acquired by the BMS sensor 116) including, but not limited to, voltage, temperature, current, and state of charge (“SOC”). The BMS 112 may also be configured to provide direct current (“DC”) power from the battery system to the motor controller 110 to power the motor 53 based on driving demands of the vehicle 10.

According to an exemplary embodiment, the motor controller 110 is configured to manage the power supplied to the motor 53. By way of example, the motor controller 110 may be configured to modulate the voltage, current, phase, and/or frequency of the power sent to the motor windings 55, which can influence the torque and speed output provided by the motor 53. In some embodiments, the motor controller 110 is configured to control a type of power, AC power or DC power, delivered to the motor 53. By way of example, the motor controller 110 may be configured to convert the type of power from DC power to AC power and/or regulate the AC power or DC power depending on the intended function of the motor 53. The motor controller 110 may include components to invert, convert, or otherwise modulate DC power and/or AC power.

As shown in FIG. 3, the energy storage 54 is configured to supply (e.g., via electrical wiring, electrical connections, etc.) DC power to the motor controller 110. In some embodiments, the DC power flows from the energy storage 54, through the BMS 112, and to the motor controller 110. The BMS 112 and the motor controller 110 may include communication interfaces (e.g., communications interfaces 106) that facilitate exchanging data related to operational status, command signals, and feedback therebetween. The BMS 112 and the add-on battery module 59 (e.g., a BMS thereof) may include communication interfaces that facilitate exchanging data related to operational status, command signals, and feedback therebetween. The add-on battery module(s) 59 is(are) configured to provide additional battery cells and increase the total energy storage capacity of the energy storage 54. As shown in FIG. 3, the battery module 57 and the add-on battery module(s) 59 are connected in parallel (e.g., via wires, connection busses, etc.) to provide for a pathway of electrical transfer. In other embodiments, the battery module 57 and the add-on battery module(s) 59 are connected in series.

According to an exemplary embodiment, the BMS 112 is configured to monitor (e.g., continuously, periodically, etc.) various parameters of the energy storage 54, including voltage, current, and temperature of each cell, rows/groups, and/or module within the energy storage 54. In some embodiments, the BMS 112 is configured to calculate or otherwise determine the SOC of the energy storage 54, the battery module 57, and/or the add-on battery module(s) 59. In some embodiments, the BMS 112 is configured to redistribute charge among the cells, rows/groups, and/or the modules to ensure an equal or substantially equal charge level throughout the energy storage 54. The BMS 112 can communicate with other systems or components or the vehicle 10 or with external devices (e.g., the remote systems 240) to report on battery status and diagnostics and/or to receive control commands.

According to an exemplary embodiment, the BMS 112 is configured to detect faults or failures in the energy storage 54 that may potentially lead to or that have caused an overcharge condition and, thereby, a thermal runaway event. By way of example, the BMS 112 may be configured to monitor the voltage of individual cells, rows/groups, or modules of the energy storage 54, and when deviations from normal voltage levels occur beyond a nominal range, the BMS 112 may determine that a fault or failure is present and that there is a potential for an overcharge condition or that there is an actual overcharge condition. In some implementations, the BMS 112 is configured to detect voltage imbalance or voltage imbalance trends. By way of another example, the BMS 112 may additionally or alternatively be configured to monitor current flows during charging and discharging of the energy storage 54 and identify unexpected fluctuations in current that may indicate that a fault or failure is present and that there is a potential for an overcharge condition or that there is an actual overcharge condition. By way of still another example, the BMS 112 may additionally or alternatively be configured to monitor the temperature of the cells, rows/groups, and/or modules of the energy storage 54 and identify anomalously high temperatures that may indicate that a fault or failure is present and that there is a potential for an overcharge condition or that there is an actual overcharge condition. It should be understood that the above example of detecting faults, failures, or overcharge conditions is provided for example purposes only and is not exhaustive. Other methods or techniques may be implemented to detect faults, failures, or overcharge conditions, which are intended to be included within the scope of the present disclosure. Additional details regarding fault detection regarding the energy storage 54 is described in greater detail herein. Further details regarding fault detection, including voltage imbalance, may be found in U.S. patent application Ser. No. 18/884,363, filed Sep. 13, 2024, which is incorporated herein by reference in its entirety.

### Fleet Monitoring and Control System

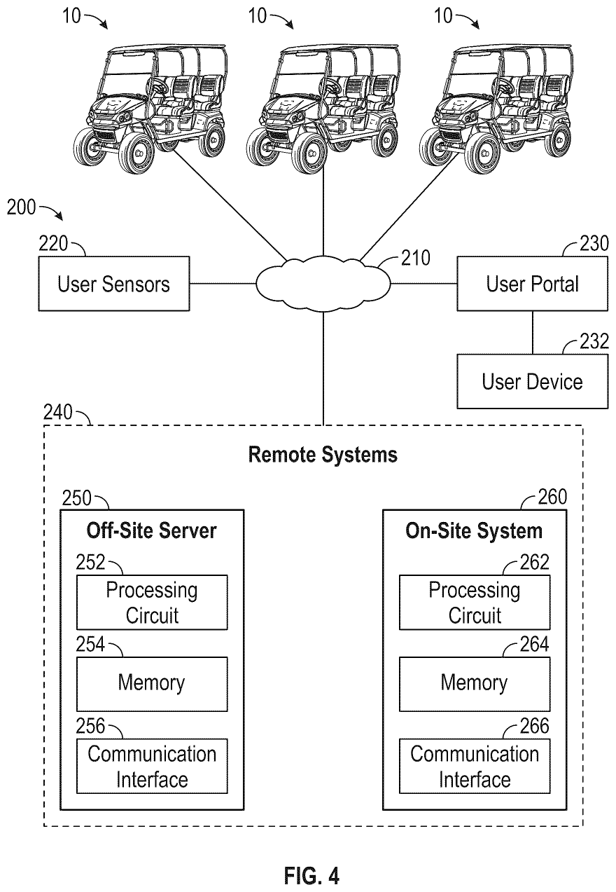

As shown in FIG. 4, a site monitoring and control system, shown as fleet monitoring and control system 200, includes one or more vehicles 10; one or more second sensors, shown as user sensors 220, positioned remote or separate from the vehicles 10; an operator interface, shown as user portal 230, positioned remote or separate from the vehicles 10; an external or remote user device, shown as user device 232, positioned remote or separate from the vehicles 10; and one or more external processing systems, shown as remote systems 240, positioned remote or separate from the vehicles 10. The vehicles 10, the user sensors 220, the user portal 230, and the remote systems 240 communicate via one or more communications protocols (e.g., Bluetooth, Wi-Fi, cellular, radio, through the Internet, etc.) through a network, shown as communications network 210. In some embodiments, the fleet monitoring and control system 200 does not includes the user portal 230 and/or the user device 232.

The user sensors 220 may be or include one or more sensors that are carried by or worn by an operator of one of the vehicles 10. By way of example, the user sensors 220 may be or include a wearable sensor (e.g., a smartwatch, a fitness tracker, a pedometer, a heart rate monitor, etc.) and/or a sensor that is otherwise carried by the operator (e.g., a smartphone, etc.) that facilitates acquiring and monitoring operator data (e.g., physiological conditions such a temperature, heartrate, breathing patterns, etc.; location; movement; etc.) regarding the operator. The user sensors 220 may communicate directly with the vehicles 10, directly with the remote systems 240, and/or indirectly with the remote systems 240 (e.g., through the vehicles 10 as an intermediary).

The user portal 230 may be configured to facilitate operator access to dashboards including the vehicle data, the operator data, information available at the remote systems 240, etc. to manage and operate the site (e.g., golf course) such as for advanced scheduling purposes, to identify persons breaking course guidelines or rules, to monitor locations of the vehicles 10, etc. The user portal 230 may also be configured to facilitate operator implementation of configurations and/or parameters for the vehicles 10 and/or the site (e.g., setting speed limits, setting geofences, etc.). As shown in FIG. 4, the user portal 230 is accessible via the user device 232. The user device 232 may be or include a computer, laptop, smartphone, tablet, or the like. The user portal 230 and the user device 232 may communicate via one or more communications protocols (e.g., Bluetooth, Wi-Fi, cellular, radio, through the Internet, wired connection, etc.) through a network (e.g., a CAN bus, the communications network 210, etc.). The user device 232 includes a display (e.g., a screen, etc.) configured to display one or more graphical user interfaces (“GUIs”) of the user portal 230.

As shown in FIG. 4, the remote systems 240 include a first remote system, shown as off-site server 250, and a second remote system, shown as on-site system 260 (e.g., in a clubhouse of a golf course, on the golf course, etc.). In some embodiments, the remote systems 240 include only one of the off-site server 250 or the on-site system 260. As shown in FIG. 4, (a) the off-site server 250 includes a processing circuit 252, a memory 254, and a communications interface 256 and (b) the on-site system 260 includes a processing circuit 262, a memory 264, and a communications interface 266.

According to an exemplary embodiment, the remote systems 240 (e.g., the off-site server 250 and/or the on-site system 260) are configured to communicate with the vehicles 10 and/or the user sensors 220 via the communications network 210. By way of example, the remote systems 240 may receive the vehicle data from the vehicles 10 and/or the operator data from the user sensors 220. The remote systems 240 may be configured to perform back-end processing of the vehicle data and/or the operator data. The remote systems 240 may be configured to monitor various global positioning system (“GPS”) information and/or real-time kinematics (“RTK”) information (e.g., position/location, speed, direction of travel, geofence related information, etc.) regarding the vehicles 10 and/or the user sensors 220. The remote systems 240 may be configured to transmit information, data, commands, and/or instructions to the vehicles 10. By way of example, the remote systems 240 may be configured to transmit GPS data and/or RTK data based on the GPS information and/or RTK information to the vehicles 10 (e.g., which the vehicle control systems 100 may use to make control decisions). By way of another example, the remote systems 240 may send commands or instructions to the vehicles 10 to implement.

According to an exemplary embodiment, the remote systems 240 (e.g., the off-site server 250 and/or the on-site system 260) are configured to communicate with the user portal 230 via the communications network 210. By way of example, the user portal 230 may facilitate (a) accessing the remote systems 240 to access data regarding the vehicles 10 and/or the operators thereof and/or (b) configuring or setting operating parameters for the vehicles 10 (e.g., geofences, speed limits, times of use, permitted operators, etc.). Such operating parameters may be propagated to the vehicles 10 by the remote systems 240 (e.g., as updates to settings) and/or used for real time control of the vehicles 10 by the remote systems 240.

### Data Transfer Between Golf Vehicles

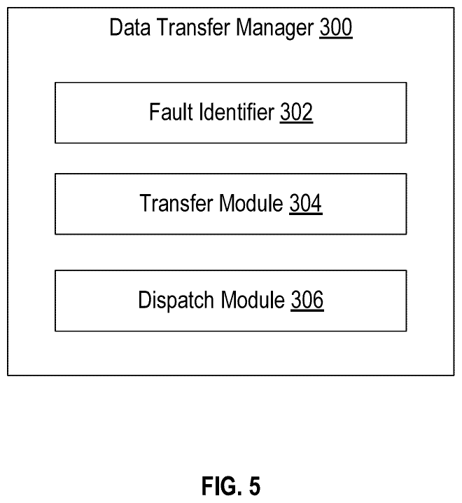

As shown in FIG. 5, a data transfer manager 300 is shown, according to an exemplary embodiment. The data transfer manager 300 is configured to transfer data associated with a first vehicle 10 and/or a golfer using the first vehicle 10 to a second vehicle 10. Particularly, the data transfer manager 300 transfers the data in response to or following an occurrence of a fault of the first vehicle 10. The data transfer manager 300 may be part of the remote systems 240 and/or the vehicle control system 100. The data transfer manager 300 includes a fault identifier 302, a transfer module 304, and a dispatch module 306.

The data transfer manager 300 includes a fault identifier 302. The fault identifier 302 is or includes any device, component, element, or hardware designed or configured to determine that a fault is occurring on a first vehicle 10. The fault identifier 302 is communicably coupled to the transfer module 304 and the dispatch module 306.

The fault identifier 302 determines that a first vehicle 10 is experiencing a fault. For example, the first vehicle 10 may be in use by one or more golfers on a golf course (e.g., one or more golfers are using the first vehicle 10 during a round of golf). During use, the first vehicle 10 may experience a fault that prevents further use of the first vehicle 10 by the golfer or golfers. For example, the first vehicle 10 may get or have a flat tire, a dead battery, or other mechanical and/or electrical condition causing the first vehicle 10 to be out of order. Upon the occurrence of the condition causing the first vehicle 10 to be out of order, the one or more sensors 90 on the first vehicle 10 acquire or receive sensor data indicative of the condition and generate a fault. For example, the first vehicle 10 may get a flat tire. A sensor 90 (e.g., a TPMS sensor) positioned proximate or within the tire may receive an indication of the flat tire. The sensor transmits the data to the fault identifier 302, and the fault identifier 302 subsequently identifies or generates a fault corresponding to the mechanical/electrical condition. In some embodiments, an operator of the first vehicle 10 (e.g., a golfer) can transmit an indication to the clubhouse and/or golf course staff indicating that the first vehicle 10 is experiencing a fault.

In some embodiments, upon determining the fault, the fault identifier 302 receives a confirmation that the first vehicle 10 is experiencing the fault. For example, upon determination of the fault, the fault identifier 302 may transmit a request for confirmation that the fault is occurring. The request may be transmitted to, for example, a clubhouse of the golf course so that an administrator of the first vehicle 10 and/or staff member of the golf course can verify or otherwise confirm that the first vehicle 10 is experiencing a fault. Thus, in some embodiments, the confirmation of the fault is received via an interface remote from the first vehicle 10 (e.g., the user device 232). In other embodiments, the request for confirmation can be transmitted to the golfers on the first vehicle 10. For example, when the first vehicle 10 gets a flat tire, a notification may be displayed on a screen of the first vehicle 10 (e.g., the operator interface 48) that indicates a fault has been detected, and a golfer can verify, via, for example, an input to the screen, whether or not a flat tire has actually occurred. In some embodiments, the notification of the fault may include a description of the fault. For example, a notification displayed to the golfer or an employee of the golf course may indicate that a tire sensor detected an air leak and a flat tire is suspected. A corresponding fault code may also be displayed.

The data transfer manager 300 includes a transfer module 304. The transfer module 304 is or includes any device, component, element, or hardware designed or configured to transfer data from the first vehicle 10 to a second vehicle 10 responsive to an occurrence of a fault on the first vehicle 10. The transfer module 304 is communicably coupled to the fault identifier 302 and the dispatch module 306.

The transfer module 304 receives, from the fault identifier 302, an indication of a fault occurring on the first vehicle 10. Responsive to receipt of the fault and/or confirmation of the fault from the fault identifier 302, the transfer module 304 initiates a transfer of data from the first vehicle 10 to a second vehicle 10. The second vehicle 10 is a vehicle 10 that is not currently in use but is operational (e.g., is able to be used by a golfer). The data to be transferred from the first vehicle 10 to the second vehicle 10 is stored on the first vehicle 10 and/or associated with a golfer operating the first vehicle 10. For example, in various embodiments, the data to be transferred may be stored on the first vehicle 10 and/or stored on a server (e.g., the off-site server 250, the on-site system 260, elsewhere on the remote systems 240, etc.).

The data to be transferred to the second vehicle 10 may be any data utilized by the golfer or golfers while operating the first vehicle 10. For example, the data to be transferred may include a pace of play during a current round of golf for the golfer, a scorecard associated with the current round of golf, a user profile associated with the golfer, a user name associated with the golfer, a tracked travel path or trail for the first vehicle 10 during the current round of golf, etc. The data to be transferred may also include a game being played on the first vehicle 10. For example, a golfer may be able to play a virtual game with other golfers via a user interface on the first vehicle 10. The game progress and/or other associated data may be transferred to the second vehicle 10.

The data to be transferred may also include accessibility settings of the first vehicle 10 set for the golfer and/or other settings of the first vehicle 10 selected by the golfer. For example, a golfer may set certain aspects of the first vehicle 10 to conform with accessibility needs (e.g., a positioning of the vehicle seat, wheelchair accessibility, etc.). The accessibility settings may be transferred to the second vehicle 10 such that the accessibility settings are applied to the second vehicle 10 prior to the golfer using the second vehicle 10. For example, in some embodiments, the second vehicle 10 may automatically apply the accessibility settings during the data transfer. In other embodiments, a staff member of the golf course manually adjusts the second vehicle 10 (e.g., responsive to a notification from the transfer module 304 that the second vehicle 10 is to be adjusted prior to being delivered to the golfer). In some embodiments, the golfer sets certain aspects of the first vehicle 10 to conform with non-accessibility related preferences (e.g., song preferences, display settings, music volume, etc.). Transferring such settings may be performed similarly to how the accessibility settings are transferred, as described above.

The data to be transferred may also include a food and beverage order associated with the golfer. For example, a golfer may place a food and beverage order on the first vehicle 10 (e.g., via a user interface, the operator interface 48, etc.), and the fault of the first vehicle 10rt may occur prior to receipt of the food and beverage by the golfer. The order data may be transferred by the transfer module 304 such that the kitchen, halfway house, refresher/drink cart, etc. does not lose the golfer's order (e.g., the order is still fulfilled) and the course staff knows to deliver the food and beverage order to the correct location of the second vehicle 10.

In various embodiments, some or all of the data associated with the first vehicle 10 and/or the golfer is transferred. For example, a golfer may be playing a game via the operator interface 48 of the first vehicle 10 and may also be utilizing a scorecard on the operator interface 48 of the first vehicle 10. During the data transfer, the golfer may opt to transfer the scorecard to the second vehicle 10 but not the game being played. As such, in various embodiments, the transfer module 304 displays, to the golfer, via an interface of the first vehicle 10, selectable options of which data the golfer wants transferred to the second vehicle 10. The selectable options may be displayed as categories. For example, a first category of data may include round-related data, including the pace of play and scorecard information, and a second category may include golfer-related information, including a user name and a user profile. The golfer is able to select data to be transferred on a per-category and/or per-data basis.

The transfer module 304 selects the second vehicle 10 from a plurality of available vehicles 10 to transfer the data to. For example, a golf course may have a plurality of vehicles 10 that are not currently in use but available to be dispatched to golfers. The transfer module 304 may randomly select a vehicle 10, select a vehicle 10 that is first in a queue of vehicles 10, etc. In some embodiments, the transfer module 304 automatically selects the second vehicle 10 and automatically initiates the data transfer upon receiving the indication of the fault or the confirmation of the fault. In other embodiments, the transfer module 304 initiates the data transfer responsive to an indication from a user. For example, a staff member associated with the golf course may manually select, via a user interface (e.g., the user device 232) remote from the first vehicle 10 (e.g., via the remote systems 240), a second vehicle 10 to which the data is to be transferred, and may manually indicate that the transfer module 304 should initiate the data transfer.

Further, in some embodiments, upon receipt of a notification of a fault, the golfer calls to the clubhouse to request a replacement vehicle 10. In some embodiments, responsive to receipt of the call, a staff member of the golf course assigns a second vehicle 10 to the golfer. In other embodiments, the transfer module 304 may have already assigned a second vehicle 10 to the golfer (e.g., automatically in response to receipt of the fault or confirmation of the fault or manually in response to confirming the fault).

In some embodiments, the transfer module 304 causes an interface (e.g., on the first and/or second vehicle 10 and/or on an interface in the clubhouse) to display a progress bar indicative of the progress of the data transfer. The transfer module 304 transmits a notification when the data transfer is complete. The notification may be displayed on one or more of the first vehicle 10, the second vehicle 10, and/or an interface in the clubhouse (e.g., viewed by staff members).

The data transfer module 300 includes a dispatch module 306. The dispatch module 306 is or includes any device, component, element, or hardware designed or configured to dispatch the second vehicle 10 (e.g., with the transferred data) to a location of the golfer and/or the first vehicle 10. The dispatch module 306 is communicably coupled to the fault identifier 302 and the transfer module 304.

The dispatch module 306 dispatches the second vehicle 10 to a location of the first vehicle 10 and/or the golfer. The dispatch module 306 monitors a location of the first vehicle 10 and/or the golfer (e.g., via the user sensors 220), and dispatches the second vehicle 10 to the location of the first vehicle 10 and/or the golfer. The dispatch module 306 receives information indicating which second vehicle 10 the data has been transferred to, and the dispatch module 306 assigns the second vehicle 10 to the golfer, thereby allowing the second vehicle 10 to be dispatched thereto.

In some embodiments, the dispatch module 306 dispatches the second vehicle 10 to the location of the first vehicle 10 and/or the golfer by assigning a staff member (e.g., from a list of available staff member) to drive the second vehicle 10 to the location of the first vehicle 10 and/or the golfer. The dispatch module 306 may transmit the location of the first vehicle 10 and/or the golfer to the staff member and/or the second vehicle 10 such that the staff member is able to drive the second vehicle 10 to the correct location.

In some embodiments, the dispatch module 306 may dispatch the second vehicle 10 to the location of the first vehicle 10 and/or the golfer by automatically dispatching the second vehicle 10. For example, the second vehicle 10 may be an autonomously operated vehicle. Therefore, upon an indication from the dispatch module 306, the second vehicle 10 may autonomously drive itself to the location of the first vehicle 10 and/or the golfer. The dispatch module 306 may transmit the location of the first vehicle 10 and/or the golfer to the second vehicle 10 to allow the second vehicle 10 to be able to drive itself to the correct location.

The data transfer occurs prior to, concurrent with, or subsequent to the dispatch module 306 dispatching the second vehicle 10. For example, the transfer module 304 may assign a second vehicle 10 and initiate the data transfer concurrently, and the second golf cart vehicle 10 may be driven to the location of the first vehicle 10 and/or the golfer (e.g., autonomously or by a staff member) while the data is being transferred.

In various embodiments, the first vehicle 10 is in an active state until the second vehicle 10 arrives. For example, the golfers may be able to utilize features on the first vehicle 10 until the second vehicle 10 arrives at the location of the first vehicle 10. In various embodiments, the second vehicle 10 is in an inactive state until arrival at the location of the first vehicle 10. The inactive state is a state in which one or more features of the second vehicle 10 are non-functional or non-operational. For example, in the inactive state, the second vehicle 10 may be drivable but a golfer may be unable to access features such as a pace of play, a scorecard, a food and beverage ordering system, etc. or unable drive the second vehicle 10 along a path that deviates from the location of the first vehicle 10 and/or the golfer.

In various embodiments, swapping the first vehicle 10 to the second vehicle 10 may not disrupt a travel path or trail of the golfer being monitored. For example, the trail associated with a path of a golfer or group of golfers may appear continuous or near-continuous. For example, a travel path may indicate that the first vehicle 10 has been swapped with the second vehicle 10 (e.g., via an icon on an interface, etc.), but there may not be a break or a substantial break in the line indicating the travel path. In some embodiments, a map showing the travel path may also display the paths taken by the first and second vehicle 10 before and after swapping. For example, prior to the swap occurring, the interface may display a travel path showing the second vehicle 10 driving to the location of the first vehicle 10 and/or the golfer. After the swap has occurred, the interface may display a travel path showing the first vehicle 10 driving to a staging location or other vehicle bay (e.g., a location where non-operational vehicles 10 are moved).

The dispatch module 306 causes an interface to be displayed (e.g., on the first vehicle 10, the second vehicle 10, and/or a display device in the clubhouse) that indicates the status of the dispatch of the second vehicle 10. For example, an interface may display a notification to the golfer and/or a staff member that the second vehicle 10 has been dispatched. The dispatch module 306 may also cause a progress indicator to be displayed that indicates a movement progress of the second vehicle 10 to the location of the first vehicle 10 and/or the golfer. For example, the progress bar may display a warning when the second vehicle 10 is about to be dispatched, may provide real-time location updates as the second vehicle 10 moves, and/or may display a warning when the second vehicle 10 is about to arrive at the location of the first vehicle 10 and/or the golfer. The progress indicator may be, for example, a status bar, a map showing the location of the second vehicle 10 on the golf course and/or relative to the location of the first vehicle 10 and/or the golfer, etc.

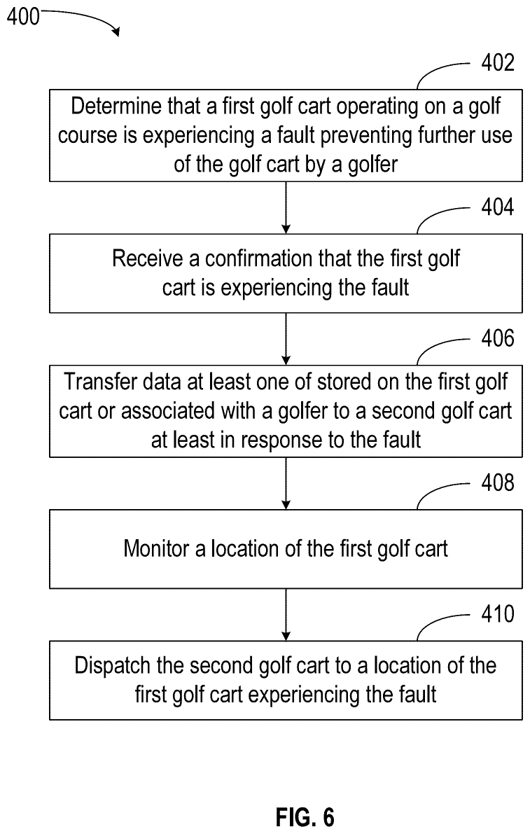

As shown in FIG. 6, a method 400 for data transfer is shown, according to an exemplary embodiment. The method is performed by one or more of the components of the data transfer manager 300, the fleet monitoring and control system 200, the remote systems 240, and/or the vehicle control system 100.

At process 402, the fault identifier 302 determines that a first golf cart (e.g., the vehicle 10) operating on a golf course is experiencing a fault. The fault prevents further use of the first golf cart by a golfer. The fault may be at least one of a flat tire, a dead battery, or an out of order error. The fault identifier 302 may determine that the first golf cart is experiencing the fault in response to a user input provided to an interface of the first golf cart. In some embodiments, the fault identifier 302 may determine that the first golf cart is experiencing the fault based on sensor data acquired from one or more sensors of the first golf cart.

At process 404, the fault identifier 302 receives a confirmation that the first golf cart is experiencing the fault. Prior to receipt of the confirmation, the fault identifier 302 requests a confirmation (e.g., from a golfer on the first golf cart and/or a staff member of the golf course) that the first golf cart is experiencing the fault. The fault identifier 302 may receive the confirmation via an interface of the first golf vehicle (e.g., when confirmation is received from the golfer). In some embodiments, the fault identifier 302 receives the confirmation via an interface remote from the first golf vehicle (e.g., when confirmation is received from a staff member).

At process 406, the transfer module 304 transfers golfer and/or vehicle data that is at least one of stored on the first golf cart or associated with the golfer to a second golf cart. The transfer module 304 transfers the golfer and/or vehicle data to the second golf cart in response to the fault. The transfer module 304 may transfer the golfer and/or vehicle data to the second golf cart in response to the fault and in response to receiving the confirmation. The transfer module 304 may also transfer the golfer and/or vehicle data in response to receipt of approval from a staff member associated with the golf course. The transfer module 304 transfers the golfer and/or vehicle data from at least one of the first golf vehicle or a server to the second golf vehicle.

The golfer and/or vehicle data transferred by the transfer module 304 may include at least one of a pace of play during a current round of golf for the golfer, a scorecard associated with the current round of golf, a user profile associated with the golfer, a user name associated with the golfer, a game being played at the first golf cart, a golf cart trail for the first golf cart during the current round of golf, accessibility settings of the first golf cart set for the golfer, a food and beverage order associated with the golfer, or golf cart settings of the first golf cart selected by the golfer.

At process 408, the dispatch module 306 monitors a location of the first golf cart. The dispatch module 306 monitors first locations of the first golf vehicle as the first golf vehicle drives around the golf course. The dispatch module 306 generates a cart trail based on the first locations and determines a fault location of the first golf vehicle when the fault occurs. The dispatch module 306 subsequently monitors second locations of the second golf vehicle as the second golf vehicle drives around the golf course and continues generating the cart trail from the fault location based the second locations.

At process 410, the dispatch module 306 dispatches the second golf cart to a location of the first golf cart and/or the golfer. In some embodiments, the dispatch module 306 causes the second golf cart to autonomously drive to the location of the first golf cart and/or the golfer. In some embodiments, the dispatch module 306 instructs a staff member associated with the golf course to drive the second golf cart to the location. Prior to dispatching the second golf cart, the dispatch module 306 (or the transfer module 304) assigns the second golf cart to the golfer.

The dispatch module 306 causes the second golf cart to enter an inactive state until the second golf cart arrives at the location. The dispatch module 306 transmits, to the golfer and and/or the staff member, a notification indicating that the second golf cart has been dispatched. The notification is transmitted to at least one of a user device associated with the golfer, an interface of the first golf vehicle, or a user device associated with the staff member.

As utilized herein with respect to numerical ranges, the terms “approximately,” “about,” “substantially,” and similar terms generally mean +/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

The hardware and data processing components used to implement the various processes, operations, illustrative logics, logical blocks, modules, and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10 and the systems and components thereof (e.g., the body 20, the operator controls 40, the driveline 50, the suspension system 60, the braking system 70, the sensors 90, the vehicle control system 100, etc.) and the fleet monitoring and control system 200 (e.g., the remote systems 240, the user portal 230, the user sensors 220, etc.) as shown in the various exemplary embodiments is illustrative only. Additionally, any element disclosed in one embodiment may be incorporated or utilized with any other embodiment disclosed herein.

1. A golf cart system comprising:
one or more processing circuits including one or more memory devices coupled to one or more processors, the one or more memory devices configured to store instructions thereon that, when executed by the one or more processors, cause the one or more processors to:
determine that a first golf cart operating on a golf course is experiencing a fault preventing further use of the first golf cart by a golfer; and
transfer data at least one of stored on the first golf cart or associated with the golfer to a second golf cart at least in response to the fault.

2. The golf cart system of claim 1, wherein the fault comprises at least one of: a flat tire, a dead battery, or an out of order error.

3. The golf cart system of claim 1, wherein the instructions cause the one or more processing circuits to determine that the first golf cart is experiencing the fault in response to a user input provided to an interface of the first golf cart.

4. The golf cart system of claim 1, wherein the instructions cause the one or more processing circuits to determine that the first golf cart is experiencing the fault based on data acquired from one or more sensors of the first golf cart.

5. The golf cart system of claim 1, wherein the instructions cause the one or more processing circuits to:
request confirmation that the first golf cart is experiencing the fault; and
transfer the data to the second golf cart in response to the fault and in response to receiving the confirmation.

6. The golf cart system of claim 5, wherein the confirmation is received via an interface of the first golf cart.

7. The golf cart system of claim 5, wherein the confirmation is received via an interface remote from the first golf cart.

8. The golf cart system of claim 1, wherein the data is transferred in response to the one or more processing circuits receiving approval from a staff member associated with the golf course.

9. The golf cart system of claim 1, wherein the data includes at least one of a pace of play during a current round of golf for the golfer, a scorecard associated with the current round of golf, a user profile associated with the golfer, a user name associated with the golfer, a game being played, a golf cart trail for the first golf cart during the current round of golf, accessibility settings of the first golf cart set for the golfer, a food and beverage order associated with the golfer, or golf cart settings of the first golf cart selected by the golfer.

10. The golf cart system of claim 1, wherein the instructions cause the one or more processors to:
monitor a location of the first golf cart; and
dispatch the second golf cart to the location of the first golf cart.

11. The golf cart system of claim 10, wherein the instructions cause the one or more processors to autonomously drive to the second golf cart to the location.

12. The golf cart system of claim 10, wherein the instructions cause the one or more processors to:
assign the second golf cart to the golfer; and
instruct a staff member associated with the golf course to drive the second golf cart to the location.

13. The golf cart system of claim 10, wherein the instructions cause the one or more processors to cause the second golf cart to enter an inactive state until the second golf cart arrives at the location.

14. The golf cart system of claim 1, wherein the instructions cause the one or more processors to transmit, to a user of the golf cart, a notification indicating that the second golf cart has been dispatched.

15. The golf cart system of claim 14, wherein the notification is transmitted to at least one of a user device associated with the golfer or an interface of the first golf cart.

16. The golf cart system of claim 1, wherein the instructions cause the one or more processors to:
monitor first locations of the first golf cart as the first golf cart drives around the golf course;
generate a cart trail based on the first locations;
determine a fault location of the first golf cart when the fault occurs;
monitor second locations of the second golf cart as the second golf cart drives around the golf course; and
continue generating the cart trail from the fault location based the second locations.

17. The golf cart system of claim 1, wherein the data is transferred from (a) at least one of the first golf cart or a server to (b) the second golf cart.

18. A system comprising:
one or more processing circuits including one or more memory devices coupled to one or more processors, the one or more memory devices configured to store instructions thereon that, when executed by the one or more processors, cause the one or more processors to:
determine that a first golf cart operating on a golf course is experiencing a fault preventing further use of the first golf cart by a golfer;
transfer data at least one of stored on the first golf cart or associated with the golfer to a second golf cart at least in response to the fault;
monitor first locations of the first golf cart as the first golf cart drives around the golf course;
generate a cart trail based on the first locations;
determine a fault location of the first golf cart when the fault occurs;
monitor second locations of the second golf cart as the second golf cart drives around the golf course; and
continue generating the cart trail from the fault location based the second locations.

19. The system of claim 18, wherein the instructions cause the one or more processing circuits to:
request confirmation that the first golf cart is experiencing the fault; and
transfer the data to the second golf cart in response to the fault and in response to receiving the confirmation.

20. A golf cart system comprising:
one or more processing circuits including one or more memory devices coupled to one or more processors, the one or more memory devices configured to store instructions thereon that, when executed by the one or more processors, cause the one or more processors to:
determine that a first golf cart operating on a golf course is experiencing a fault preventing further use of the first golf cart by a golfer;
transfer data at least one of stored on the first golf cart or associated with the golfer to a second golf cart at least in response to the fault;
monitor a location of the first golf cart;
dispatch the second golf cart to the location of the first golf cart; and
one of:
(a) autonomously drive to the second golf cart to the location; or
(b) assign the second golf cart to the golfer and instruct a staff member associated with the golf course to drive the second golf cart to the location.
